(19) United States
(12) Patent Application Publication
(10) Pub. No.: US 2006/0013506 A1
(43) Pub. Date: Jan. 19, 2006

(54) Inverse transform method, apparatus, and medium

(75) Inventors: Byung-cheol Song, Suwon-si (KR); Kang-wook Chun, Hwaseong-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/183,976

(22) Filed: Jul. 19, 2005

(30) Foreign Application Priority Data
Jul. 19, 2004 (KR) 2004-55894

(51) Int. Cl. G06K 9/03

(52) U.S. Cl. 382/309

(57) ABSTRACT

An inverse transform apparatus included in a moving-image codec, and more particularly, an inverse transform method, apparatus, and medium unrestricted by a size or a type of input data is provided. The inverse transform apparatus included in the moving-image codec may include a plurality of ROM tables separately included according to a format or a size of input data to be referred to in the case of an inverse transform and an inverse transform processor selecting one of the ROM tables according to the format or the size of the input data and performing an inverse transform on the input data. Accordingly, an inverse transform method and apparatus unrestricted by the size or the type of input data is provided. In addition, a multi-format decoder supporting various sizes, such as 8×8, 8×4, 4×8, and 4×4, and various formats, such as VC9 and MPEG-2, can be embodied.

### CROSS-REFERENCE TO RELATED APPLICATIONS

This application claims the benefit of Korean Patent Application No. 10-2004-0055894, filed on Jul. 19, 2004, in the Korean Intellectual Property Office, the disclosure of which is incorporated herein in its entirety by reference.

### BACKGROUND OF THE INVENTION

1. Field of the Invention

The present invention relates to an inverse transform apparatus included in a moving-image codec, and more particularly, to an inverse transform method, apparatus, and medium unrestricted by the size or the type of input data.

2. Description of the Related Art

Recently, Microsoft has submitted its prospective moving-image compression standard, VC9, to the Society of Motion Picture and Television Engineers (SMPTE), which is one of the international standardization organizations. VC9 is under active consideration and, after some modifications, expected to be adopted as an international standard in the foreseeable future.

Therefore, VC9 is expected to take root as another representative image-compression standard in addition to motion-picture experts group (MPEG)-2, MPEG-4, and H.264, which have already been adopted as moving-image compression standards and applied widely. The compression efficiency of VC9 is close to 80 percent of that of H.264, which is the best of all, while its implementation complexity is only about 60 percent of that of H. 264. Therefore, VC9 is being recognized as having a superior performance rate compared with its implementation complexity. In addition, VC9 is known to provide better image quality than MPEG-2 or MPEG-4.

VC9 has tools slightly changed from those used by conventional standards. In particular, in the case of an inverse transform, while MPEG-2 performs an inverse discrete cosine transform (IDCT) on data of a fixed size, such as 8×8, VC9 can perform an integer inverse transform on data of various sizes, such as 8×8, 8×4, 4×8, and 4×4. Further, there has been growing interest in multi-format decoders supporting multi-formats, such as MEPG-2 and VC9. The multi-format decoders should be able to decode data of various formats and sizes using the same hardware structure, if possible.

### SUMMARY OF THE INVENTION

Additional aspects, features, and/or advantages of the invention will be set forth in part in the description which follows and, in part, will be obvious from the description, or may be learned by practice of the invention.

The present invention provides an inverse transform method, apparatus, and medium unrestricted by a format or a size of input data and using the same hardware structure to embody a multi-format decoder.

According to an aspect of the present invention, there is provided an inverse transform apparatus included in a moving-image codec. The apparatus includes a plurality of ROM tables separately included according to a format or a size of input data to be referred to in performing an inverse transform; and an inverse transform processor selecting one of the ROM tables according to the format or the size of the input data and performing an inverse transform on the input data.

The format may include at least one of MPEG-2 and VC9. The size may include at least one of 8×8, 8×4, 4×8, and 4×4.

The inverse transform processor may have the same structure regardless of the format or the size of the input data.

According to another aspect of the present invention, there is provided an image codec apparatus including the inverse transform apparatus and supporting multi-formats.

According to another aspect of the present invention, there is provided an inverse transform method for a moving-image codec. The method includes selecting one of a plurality of ROM tables, which are separately included according to a format or a size of input data, according to the format or the size of the input data; and performing an inverse transform on the input data with reference to the selected ROM table.

According to another aspect of the present invention, there is provided at least one computer readable medium storing instructions that control at least one processor to perform an inverse transform method for a moving-image codec, the method including selecting one of a plurality of ROM tables, which are separately included according to a format or a size of input data, according to the format or the size of the input data; and performing an inverse transform on the input data with reference to the selected ROM table.

### BRIEF DESCRIPTION OF THE DRAWINGS

These and/or other aspects, features, and advantages of the invention will become apparent and more readily appreciated from the following description of the exemplary embodiments, taken in conjunction with the accompanying drawings of which:

FIG. 1 is a conceptual diagram of an inverse transform apparatus according an exemplary embodiment of the present invention;

FIG. 2 is a block diagram of an inverse transform apparatus of an exemplary embodiment of FIG. 1;

FIGS. 3A and 3B illustrate operations of data supply units, respectively, included in the inverse transform apparatus according to exemplary embodiments of the present invention;

FIG. 4 is a block diagram of inverse transform elements (ITELs) illustrated in FIG. 2;

FIGS. 5A and 5B are detailed block diagrams of the ITELs illustrated in FIG. 4;

FIG. 6 illustrates an operation of a transpose unit of an inverse transform apparatus in the case of an 8×8 inverse transform according to exemplary embodiments of the present invention; and

FIG. 7 is a block diagram of the ITELs illustrated in FIG. 2 according to another exemplary embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

A VC9 image compression method includes four types of inverse transforms; 8×8, 8×4, 4×8, and 4×4 inverse transforms. Each of the 8×8, 8×4, 4×8, and 4×4 inverse involves three processes. First, by dividing an inverse transform into an inverse transform in a row direction and an inverse transform in a column direction, a first one-dimensional inverse transform is performed in the row direction. Then, a second one-dimensional inverse transform is performed in the column direction. To shift from the first one-dimensional inverse transform in the row direction to the second one-dimensional inverse transform in the column direction, after the first one-dimensional inverse transform, a transpose operation for changing rows to columns is performed using two registers.

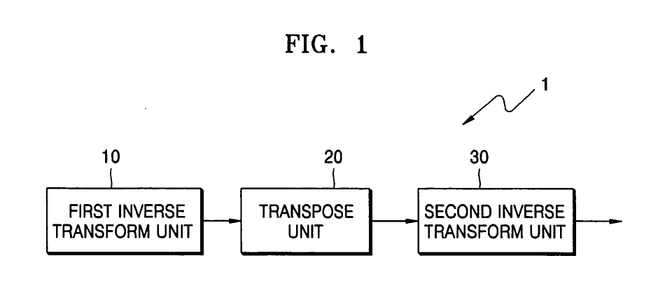

FIG. 1 is a conceptual diagram of an inverse transform apparatus 1 according an exemplary embodiment of the present invention. Referring to FIG. 1, the inverse transform apparatus 1 includes a first inverse transform unit 10 performing an one-dimensional inverse transform in the row direction, a transpose unit 20 performing a transpose operation for changing rows to columns using two registers, and a second inverse transform unit 30 performing the one-dimensional inverse transform in the column direction. The structures of the 12-bit first inverse transform unit 10 and the 16-bit second inverse transform unit 30 are almost identical although sizes of data input thereto and their ROM tables, which will be described later, are different.

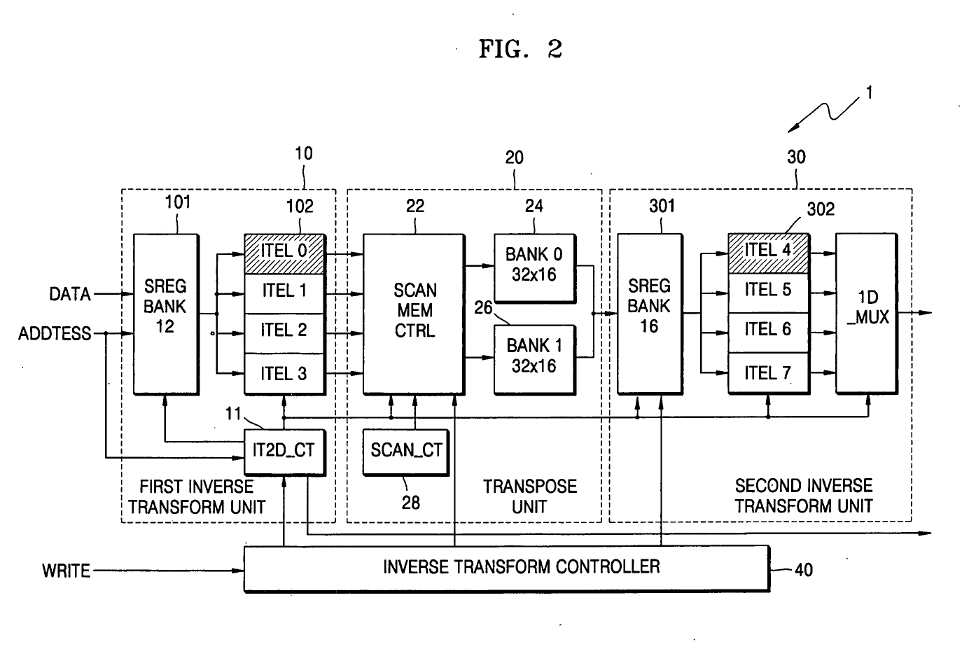

FIG. 2 is a block diagram of the inverse transform apparatus 1 of FIG. 1. Referring to FIG. 2, as described above, the inverse transform apparatus 1 includes the first inverse transform unit 10, the transpose unit 20, and the second inverse transform unit 30.

The first inverse transform unit 10 includes a data supplying unit 101 and four inverse transform elements (ITELs) 102. The data supplying unit 101 receives i_dsp2vsp_iqdata indicating data to be inverse-transformed, i_dsp2vsp_iqwr for controlling recording timing, and i_dsp2vsp_iqaddr indicating an address. Here, the i_dsp2vsp_iqdata of 24 bits is a combination of two inverse-quantized 12-bit coefficients and, in fact, uses an inverse transform input coefficient. In addition, the i_dsp2vsp_iqwr of one bit and the i_dsp2vsp_iqaddr of 2 bits are used to generate a control signal for performing an inverse transform. Since input data is 24 bits, the data supplying unit 101 is formed of sregbank 12, and there are the four ITELs 102 because data output from the four ITELs 102 is in pairs. Data in zeroth and seventh rows is output from a zeroth ITEL, data in first and sixth rows is output from a first ITEL, data in second and fifth rows is output from a second ITEL, and data in third and fourth rows is output from a third ITEL.

The transpose unit 20 performs a transpose operation to change the rows to columns of data which was one-dimensional inverse-transformed by the first inverse transform unit 10. The transpose unit 20 includes a transpose operation controller 22 (Scan Memory Controller) and two 32×16 registers 24 and 26.

The structure of the second inverse transform unit 30 is almost identical to the first inverse transform unit 10. That is, the second inverse transform unit 30 includes sregbank 16 as the data supplying unit 301 and four ITELs 302.

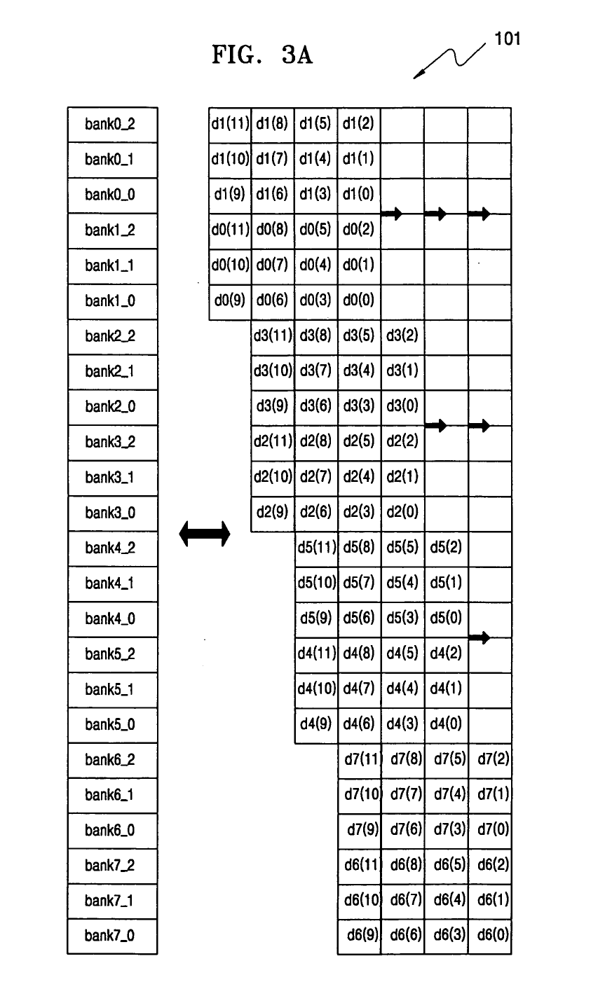

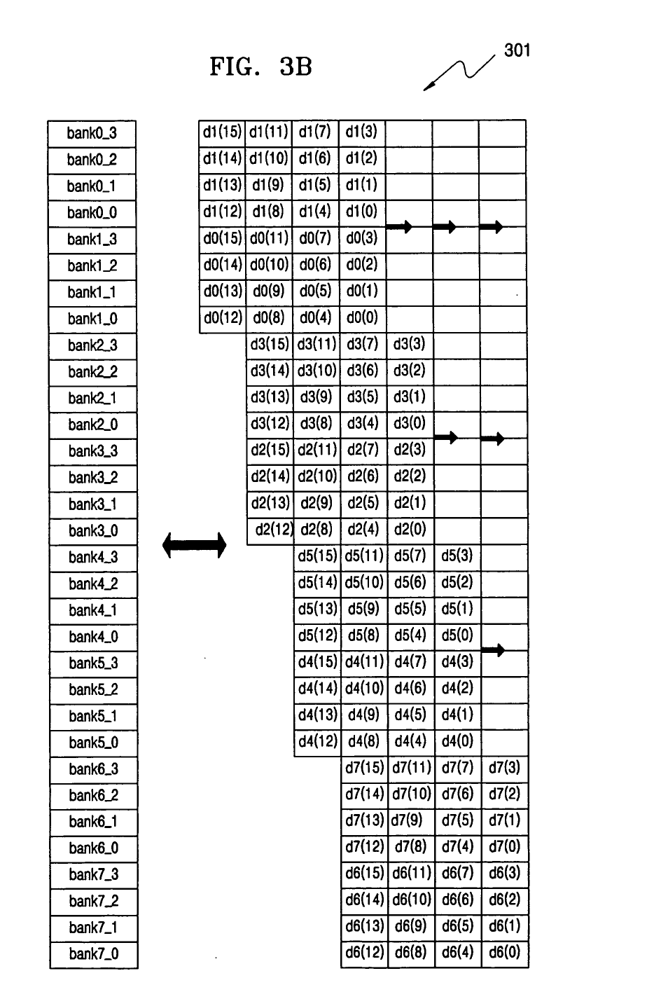

The sregbank 12 and sregbank 16, which are the data supplying units 101 and 301, have four pipeline structures and, to perform an inverse transform operation, divide input data as follows. FIGS. 3A and 3B illustrate operations of the data supply unit 101 and 301, respectively, included in the inverse transform apparatus 1 according to the present invention.

A method of supplying data in the case of the 8×8 inverse transform will now be described with reference to FIGS. 3A, 3B, and 2. Data in two of data banks is swapped for every clock. Since data is shifted by one bit, it takes four clocks to transfer the data to all of the data banks. Zeroth and first banks, to which data is first transferred, second and third banks, fourth and fifth banks, sixth and seventh banks require 7 bits, 6 bits, 5 bits, and 4 bits, respectively. Thus, after four clocks, consecutive 3 bits of an inverse-transformed coefficient are output from the first inverse transform unit 10, and consecutive 4 bits of the inverse-transformed coefficient are output from the second inverse transform unit 30. Here, an input of the sregbank 12 is a row vector, and an input of the sregbank 16 is a column vector.

Data output from each data bank is divided into data of even data banks and that of odd data banks and combined accordingly to generate a 4-bit address. The 4-bit address is used when the ITELs 102 or 302 refer to a value in a lookup table for performing an inverse transform. The value is a pre-calculated value of cosine and data used to perform the inverse transform. The lookup table may be implemented as a ROM table, which will be described later.

Next, a method of supplying data in the case of the 8×4 inverse transform will be described. Referring to FIGS. 3A, 3B, and 2, since the number of rows of the first inverse transform unit 10 is four, not eight, four pieces of data are supplied to the first inverse transform unit 10. Hence, valid data is supplied to only first, third, fifth, and seventh banks, which are odd banks, and 0 is supplied to even banks. Since the rows and columns of the first inverse transform unit 10 are changed through the transpose operation, in the 8×4 inverse transform, data is supplied to the second inverse transform unit 30 in the same way as in the 8×8 inverse transform.

A method of supplying data in the case of the 4×8 inverse transform will now be described. Referring to FIGS. 3A, 3B, and 2, since the number of rows of the first inverse transform unit 10 is eight, in the 4×8 inverse transform, data is supplied to the first inverse transform unit 10 in the same way as in the 8×8 inverse transform. On the other hand, since the number of columns of the second inverse transform unit 30 is four, not eight, four pieces of data are sequentially supplied to the second inverse transform unit 30. Thus, valid data is supplied to only the first, third, fifth, and seventh banks, which are the odd banks, and 0 is supplied to the even banks.

Last, a method of supplying data in the case of the 4×4 inverse transform will be described. Referring to FIGS. 3A, 3B, and 2, since the number of rows of the first inverse transform unit 10 is four and the number of columns of the second inverse transform unit 30 is four, four pieces of data are sequentially supplied to the first inverse transform unit 10 and the second inverse transform unit 30, respectively. Thus, valid data is supplied to the first, third, fifth, and seventh banks, which are the odd banks, and 0 is supplied to the even banks.

Hereinafter, the structure and operation of the ITELs 102 or 302 receiving data from the data supplying unit 101 or 301 and performing an inverse transform on the data will be described.

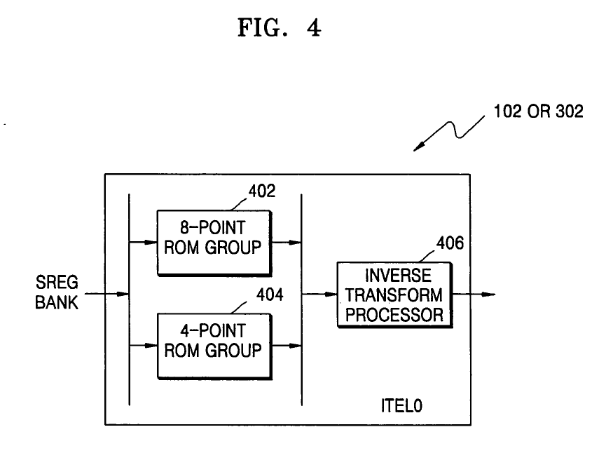

FIG. 4 is a block diagram of the ITELs 102 or 302 illustrated in FIG. 2. Referring to FIG. 4, a block structure of one ITEL is illustrated. In other words, one ITEL includes at least one ROM table including a lookup table for performing an inverse transform and an inverse transform processor 406.

The ROM table includes an 8-point ROM table group 402 for the 8×8 or 8×4 inverse transform or a 4-point ROM table group 404 for the 4×8 or 4×4 inverse transform. In other words, a ROM table corresponding to a size of input data, such as 8×8, 8×4, 4×8, or 4×4, is selected and referred to by the inverse transform processor 406 when performing the inverse transform.

Accordingly, unlike the DCT of MEPG-2 to which data of a fixed size, i.e., 8×8, is input, even if data of various sizes is input to the inverse transform apparatus 1, the inverse transform apparatus 1 can perform an inverse transform on the data of various sizes using the same hardware structure and changing a ROM table only.

The inverse transform processor 406 selects the 8-point ROM table group 402 or the 4-point ROM table group 404 according to the size of the input data and refers to a selected ROM table, i.e., the 8-point ROM table group 402 or the 4-point ROM table group 404, when performing the inverse transform.

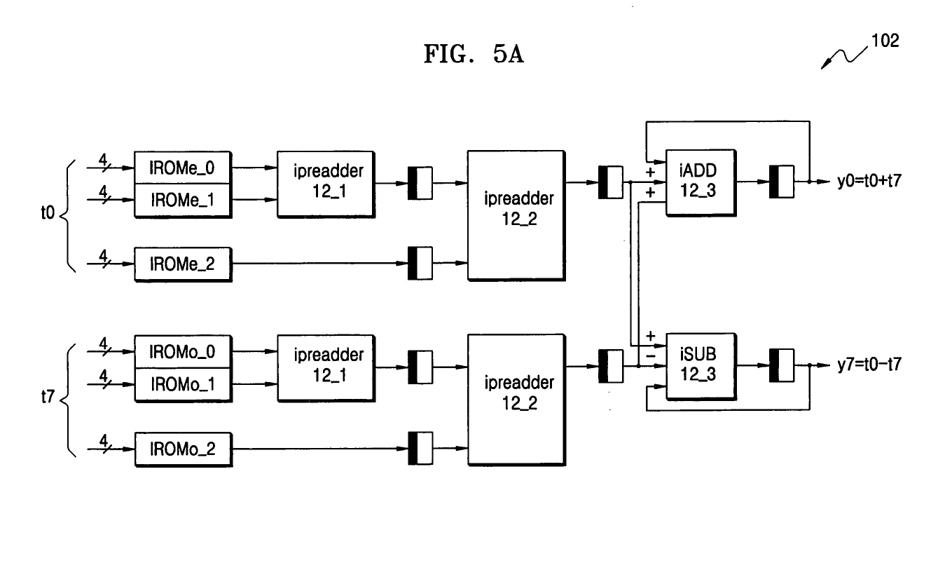

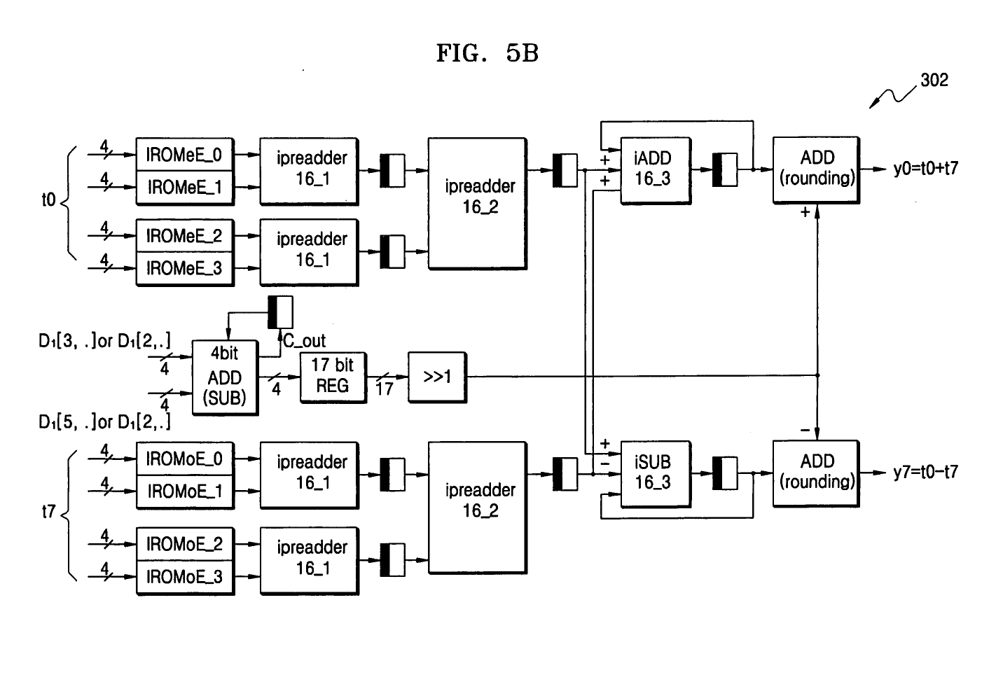

FIGS. 5A and 5B are detailed block diagrams of the ITELs 102 and 302 illustrated in FIG. 4. Specifically, FIG. 5A is a detailed block diagram of the ITELs 102 included in the first inverse transform unit 10. FIG. 5B is a detailed block diagram of the ITELs 302 included in the second inverse transform unit 30.

First, the 8×8 inverse transform will be described. Referring to FIGS. 5A and 2, in the first inverse transform unit 10, one ITEL requires two types of ROM tables. For example, zeroth and seventh ROM tables IROM0 and IROM7 are used in the zeroth ITEL, the first and sixth ROM tables IROM1 and IROM6 are used in the first ITEL, the second and fifth ROM tables IROM2 and IROM5 are used in the second ITEL, and the third and fourth ROM tables IROM3 and IROM4 are used in the third ITEL. In other words, even ROM tables, i.e., IROMe, and odd ROM tables, i.e., IROMo, are used in one ITEL.

In an exemplary embodiment, if an ITEL receives 3-bit data from the data supplying unit 101, three ROM tables corresponding to the 3-bit input data, respectively, are required. For example, the zeroth ITEL includes IROM0_0, IROM0_1, and IROM0_2 as even ROM tables and IROM7_0, IROM7_1, and IROM7_2 as odd ROM tables. To make generalizations, each ITEL includes IROMe_0, IROMe_1, and IROMe_2 as even ROM tables and IROM0_0, IROM0_1, and IROM0_2 as odd ROM tables. That is, since the ITELs 102 of the first inverse transform unit 10 process 3-bit data at a time, each of the ITELs 102 requires three identical ROM tables. Data generated by a ROM table IROM is combined by a shifter and an adder into image data.

More specifically, the operation of the zeroth ITEL of the first inverse transform unit 10 will be described. IROMe_0, IROMe_1, IROMe_2 are identical ROM tables but are different in that data is input thereto in four-bit units. For example, if three addresses of LSB, LSB+1, and LSB+2 are input to IROMe_0, IROMe_1, and IROMe_2, ipreadder12_1, which is a first adder, adds data output from IROMe_0 and IROMe_1 as preliminary processing. Here, an output value of IROMe_1 is left-shifted by one bit before addition by ipreadder12_1. Data output from IROMe_2 is latched, which is then added to an output value of the ipreadder12_1 by ipreadder12_2, which is a second adder. Here, IROMe_2 is left-shifted by two bits before addition by ipreadder12_2, and an output value of IROMe_2 is latched. An output value of the ipreadder12_2 is a result of up to three least significant bits (LSBs) of t0.

A result of up to three LSBs of t7 can also be obtained using the same method. iADD12_3, which is a third adder, adds and latches t0 and t7. The iADD12_3 adds t0 and t7 to a result of left-shifting the next 3 bits by 3 bits. Consequently, an inverse transform value of y0 can be output. Meanwhile, iSUB12_3, which is a third subtractor, can subtract t7 from to and output an inverse transform value of y7. If three bits are processed simultaneously, four rounds of the same operation will produce a final result for a total of 12 bits.

In this way, if a one-dimensional inverse transform value in the row direction is output, column vectors are input to the data supplying unit 301 of the second inverse transform unit 30 through the transpose operation of the transpose unit 20. FIG. 5B illustrates the structure of the ITELs 302 included in the second transform unit 30 in detail.

Referring to FIGS. 5B and 2, in the second inverse transform unit 30, one ITEL requires two types of ROM tables. For example, IROM0E and IROM7E are used in the fourth ITEL, IROM1E and IROM6E are used in the fifth ITEL, IROM2E and IROM5E are used in the sixth ITEL, and IROM3E and IROM4E are used in the seventh ITEL. In other words, even ROM tables, i.e., IROMeEd and odd ROM tables, i.e., IROMoE, are used in one ITEL. Here, E indicates a ROM table including a look-up table needed when the second inverse transform unit 30 performs the inverse transform in the column direction.

In an exemplary embodiment, if an ITEL receives 4-bit data from the data supplying unit 301, four ROM tables corresponding to the 4-bit input data, respectively, are required. For example, the fourth ITEL includes IROM0E_0, IROM0E_1, IROM0E_2, and IROM0E_3 as even ROM tables and IROM7E_0, IROM7E_1, IROM7E_2, and IROM7E_3 as odd ROM tables. To make generalizations, each ITEL includes IROMeE_0, IROMeE_1, IROMeE-2, and IROMeE_3 as even ROM tables and IROMoE_0, IROMoE_1, IROMoE_2, and IROMoE_3 as odd ROM tables. In other words, since the ITELs 302 of the second inverse transform unit 30 process 4-bit data at a time, each of the ITELs 302 requires four identical ROM tables. Data generated by a ROM table IROM is combined by a shifter and an adder into image data.

More specifically, the operation of the fourth ITEL of the second inverse transform unit 30 will be described. IROMeE_0, IROMeE_1, IROMeE_2, and IROMeE_3 are identical ROM tables but are different in that data is input thereto in 4-bit units. For example, if four addresses of LSB, LSB+1, LSB+2, and LSB+3 are input to IROMeE 0, IROMeE_1, IROMeE_2, and IROMeE_3, ipreadder16_1, which is a first adder, adds data output from IROMeE_0 and IROMeE_1 as preliminary processing. An output value of IROMeE_1 is left-shifted by one bit before addition by ipreadder16_1.

Meanwhile, data output from IROMeE_2 and IROMeE_3 is added and latched, which is then added to an output value of the ipreadder16_1 by ipreadder16_2, which is a second adder. IROMeE_2 is left-shifted by two bits and added to IROMeE_3 left-shifted by three bits. Then, an output value of the addition is latched. An output value of the ipreadder16_2 is a result of up to four LSBs of t0.

A result of up to four LSBs of t7 can also be obtained using the same method. iADD16_3, which is a third adder, adds and latches t0 and t7. Then, the iADD16_3 adds t0 and t7 to a result of left-shifting the next 4 bits by 4 bits. Consequently, an inverse transform value of y0 can be output. Meanwhile, iSUB16_3, which is a third subtractor, can subtract t7 from t0 and output an inverse transform value of y7.

The 8×4 inverse transform will now be described. In the case of the 8×4 inverse transform in the row direction, since the number of rows of input data is four, not eight, four ROM tables are enough. In other words, in the case of the first inverse transform unit 10, IROM0′ is used in the zeroth ITEL, IROM1′ is used in the first ITEL, IROM2′ is used in the second ITEL, and IROM3′ is used in the third ITEL. As illustrated in FIG. 4, the 4-point ROM table group 404 is used.

Values of ROM tables used in the 8×4 inverse transform are different from those of ROM tables used in the 8×8 inverse transform. Therefore, an appropriate ROM table group has to be selected depending on whether the input data is 8×8 or 8×4. An appropriate ROM table group may be selected using a multiplexer. Other operations in the 8×4 inverse transform are the same as in the case of the 8×8 inverse transform. Also, the 8×4 inverse transform in the column direction after the transpose operation is the same as in the 8×8 inverse transform since the number of columns is eight.

The 4×8 inverse transform will now be described. In the case of the 4×8 inverse transform in the row direction, since the number of rows is eight, the number of ROM tables required is the same as in the case of the 8×8 inverse transform. In the case of the 4×8 inverse transform in the column direction, since the number of columns is four, the 4-point ROM table group 404 is used. In other words, in the case of the second inverse transform unit 30, IROM0E′ is used in the fourth ITEL, IROM1E′ is used in the fifth ITEL, IROM2E′ is used in the sixth ITEL, and IROM3E′ is used in the seventh ITEL.

Last, the 4×4 inverse transform will now be described. In the case of the 4×4 inverse transform in the row direction, since the number of rows is four, the 4×4 inverse transform is performed in the same way as in the 8×4 inverse transform. In other words, the 4-point ROM table group 404 is used. In the case of the 4×4 inverse transform in the column direction, since the number of columns is four, the 4-point ROM table group 404 is used as in the case of the 4×8 inverse transform.

To sum up, in the present invention, as illustrated in FIG. 4, the 8-point ROM table group 402 and the 4-point ROM table group 404 are implemented separately to process data of various sizes, such as 8×8, 8×4, 4×8, and 4×4. Thus, an appropriate ROM table group can be selected according to the size of input data and referred to by the inverse transform processor 406.

Although not shown in the drawings, each of the even ROM tables of the first inverse transform unit 10 such as IROMe_0, IROMe_1, and IROMe_2 and each of the odd ROM tables such as IROMo_0, IROMo_1, and IROMo_2 include the 8-point ROM table group 402 for 8×8 or 8×4 data and the 4-point ROM table group 404 for 4×8 or 4×4 data, separately. Likewise, each of the ROM tables of the second inverse transform unit 30 includes the 8-point ROM table group 402 and the 4-point ROM table group 404 separately. The 8-point ROM table group 402 and the 4-point ROM table group 404 are multiplexed, respectively, and either of which is selected according to the size of input data and used for performing an inverse transform.

Accordingly, without modifications of hardware structure, the 8-point ROM table group 402 or the 4-point ROM table group 404 can be selected according to the size of input data and used for performing an inverse transform.

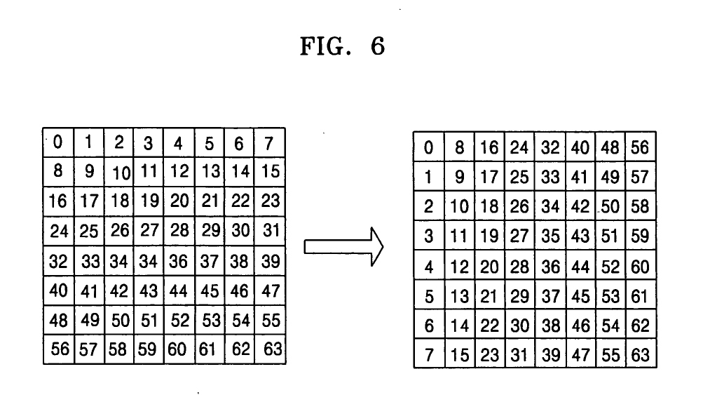

FIG. 6 illustrates an operation of the transpose unit 20 of the inverse transform apparatus 1 in the case of the 8×8 inverse transform according to the present invention. Referring to FIG. 6, the transpose unit 20 changes rows to columns such that a second inverse transform can be performed on a result of a first inverse transform in the row direction.

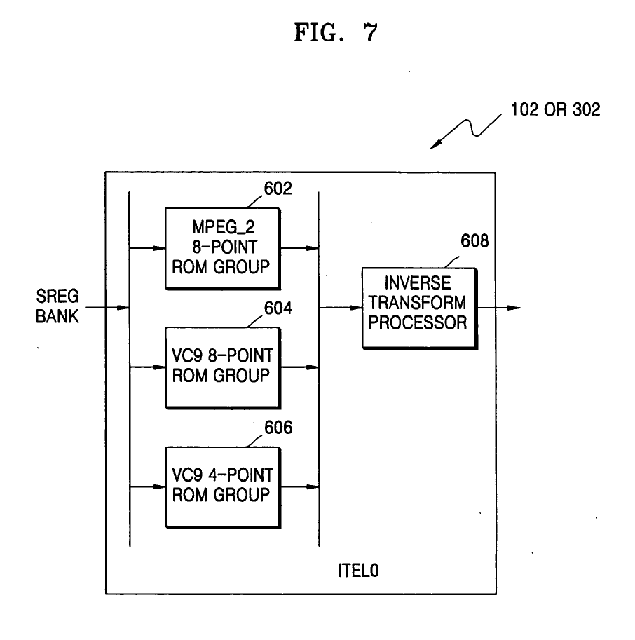

FIG. 7 is a block diagram of ITELs illustrated in FIG. 2 according to another exemplary embodiment of the present invention. Referring to FIG. 7, the present exemplary embodiment is an extension of an exemplary embodiment in which the 4-point ROM table group 404 and the 8-point ROM table group 402 are implemented separately and multiplexed such that the 4-point ROM table group 404 or the 8-point ROM table group 402 can be selected according to the size of input data. In other words, a ROM table for an 8×8 inverse discrete cosine transform (IDCT) according to the MPEG standard is additionally included and multiplexed such that an MPEG DCT, an 8-point VC9 inverse transform or a 4-point VC9 inverse transform can be performed according to the type or size of input data by using the same hardware structure.

A method of obtaining a ROM table will now be described in more detail. The 8×8 inverse transform will be used as an example. ROM tables for the 8×4, 4×8, and 4×4 inverse transforms can be obtained in a similar way.

The matrix for the 8×8 inverse transform is

$${T}_{8} = [ \begin{matrix}a & a & a & a & a & a & a & a \\ b & d & e & g & - g & - e & - d & - b \\ c & f & - f & - c & - c & - f & f & c \\ d & - g & - b & - e & e & b & g & - d \\ a & - a & - a & a & a & - a & - a & a \\ e & - b & g & d & - d & - g & b & - e \\ f & - c & c & - f & - f & c & - c & f \\ g & - e & d & - b & b & - d & e & - g\end{matrix} ] , \\ where \\ [ \begin{matrix}a \\ b \\ c \\ d \\ e \\ f \\ g\end{matrix} ] = [ \begin{matrix}12 \\ 16 \\ 16 \\ 15 \\ 9 \\ 6 \\ 4\end{matrix} ]$$

and an inverse transform of 1-Din the row direction is D₁=(D·T₈+4)>>3, where D is an inverse-transformed 8×8 input block.

The result of performing the transpose operation on D₁ is

$${D}_{1}^{′} = ( {T}_{8}^{′} \cdot {D}^{′} + 4 ) >> 3$$

$${T}_{8}^{′} = [ \begin{matrix}a & b & c & d & a & e & f & g \\ a & d & f & - g & - a & - b & - c & - e \\ a & e & - f & - b & - a & g & c & d \\ a & g & - c & - e & a & d & - f & - b \\ a & - g & - c & e & a & - d & - f & b \\ a & - e & - f & b & - a & - g & c & - d \\ a & - d & f & g & - a & b & - c & e \\ a & - b & c & - d & a & - e & f & - g\end{matrix} ] .$$

A first column (a first row of D) of D′ is
[D′[0,0] D′[1,0] D′[2,0] D′[3,0] D′[4,0] D′[5,0] D′[6,0] D′[7,0]]
where

$$[ \begin{matrix}{D}_{1}^{′} [ 0 , 0 ] \\ {D}^{′} [ 1 , 0 ] \\ {D}_{1}^{′} [ 2 , 0 ] \\ {D}_{1}^{′} [ 3 , 0 ]\end{matrix} ] = [ \begin{matrix}a & c & a & f \\ a & f & - a & - c \\ a & - f & - a & c \\ a & - c & a & - f\end{matrix} ] [ \begin{matrix}{D}^{′} [ 0 , 0 ] \\ {D}^{′} [ 2 , 0 ] \\ {D}^{′} [ 4 , 0 ] \\ {D}^{′} [ 6 , 0 ]\end{matrix} ] + [ \begin{matrix}b & d & e & g \\ d & - g & - b & - e \\ e & - b & g & d \\ g & - e & d & - b\end{matrix} ] [ \begin{matrix}{D}^{′} [ 1 , 0 ] \\ {D}^{′} [ 3 , 0 ] \\ {D}^{′} [ 5 , 0 ] \\ {D}^{′} [ 7 , 0 ]\end{matrix} ] \\ [ \begin{matrix}{D}_{1}^{′} [ 7 , 0 ] \\ {D}_{1}^{′} [ 6 , 0 ] \\ {D}^{′} [ 5 , 0 ] \\ {D}_{1}^{′} [ 8 , 0 ]\end{matrix} ] = [ \begin{matrix}a & c & a & f \\ a & f & - a & - c \\ a & - f & - a & c \\ a & - c & a & - f\end{matrix} ] [ \begin{matrix}{D}^{′} [ 0 , 0 ] \\ {D}^{′} [ 2 , 0 ] \\ {D}^{′} [ 4 , 0 ] \\ {D}^{′} [ 6 , 0 ]\end{matrix} ] - [ \begin{matrix}b & d & e & g \\ d & - g & - b & - e \\ e & - b & g & d \\ g & - e & d & - b\end{matrix} ] [ \begin{matrix}{D}^{′} [ 1 , 0 ] \\ {D}^{′} [ 3 , 0 ] \\ {D}^{′} [ 5 , 0 ] \\ {D}^{′} [ 7 , 0 ]\end{matrix} ] . \\$$

If the first column of D′ is expressed as pseudo-C codes of the inverse transform in the row direction,

$$\{ \\ t 0 = a \cdot {D}^{′} [ 0 , 0 ] + c \cdot {D}^{′} [ 2 , 0 ] + a \cdot {D}^{′} [ 4 , 0 ] + f \cdot {D}^{′} [ 6 , 0 ] ; \\ t 7 = b \cdot {D}^{′} [ 1 , 0 ] + d \cdot {D}^{′} [ 3 , 0 ] + e \cdot {D}^{′} [ 5 , 0 ] + g \cdot {D}^{′} [ 7 , 0 ] ; \\ {D}_{1}^{′} [ 0 , 0 ] = t 0 + t 7 ; \\ {D}_{1}^{′} [ 7 , 0 ] = t 0 - t 7 ; \\ \\ t 1 = a \cdot {D}^{′} [ 0 , 0 ] + f \cdot {D}^{′} [ 2 , 0 ] - a \cdot {D}^{′} [ 4 , 0 ] - c \cdot {D}^{′} [ 6 , 0 ] ; \\ t 6 = d \cdot {D}^{′} [ 1 , 0 ] - g \cdot {D}^{′} [ 3 , 0 ] - b \cdot {D}^{′} [ 5 , 0 ] - e \cdot {D}^{′} [ 7 , 0 ] ; \\ {D}_{1}^{′} [ 1 , 0 ] = t 1 + t 6 ; \\ {D}_{1}^{′} [ 6 , 0 ] = t 1 - t 6 ; \\ \\ t 2 = a \cdot {D}^{′} [ 0 , 0 ] - f \cdot {D}^{′} [ 2 , 0 ] - a \cdot {D}^{′} [ 4 , 0 ] + c \cdot {D}^{′} [ 6 , 0 ] ; \\ t 5 = e \cdot {D}^{′} [ 1 , 0 ] - b \cdot {D}^{′} [ 3 , 0 ] + g \cdot {D}^{′} [ 5 , 0 ] + d \cdot {D}^{′} [ 7 , 0 ] ; \\ {D}_{1}^{′} [ 2 , 0 ] = t 2 + t 5 ; \\ {D}_{1}^{′} [ 5 , 0 ] = t 2 - t 5 ; \\ \\ t 3 = a \cdot {D}^{′} [ 0 , 0 ] - c \cdot {D}^{′} [ 2 , 0 ] + a \cdot {D}^{′} [ 4 , 0 ] - f \cdot {D}^{′} [ 6 , 0 ] ; \\ t 4 = g \cdot {D}^{′} [ 1 , 0 ] - e \cdot {D}^{′} [ 3 , 0 ] + d \cdot {D}^{′} [ 5 , 0 ] - b \cdot {D}^{′} [ 7 , 0 ] ; \\ {D}_{1}^{′} [ 3 , 0 ] = t 3 + t 4 ; \\ {D}_{1}^{′} [ 4 , 0 ] = t 3 - t 4 ; \\ \}$$

If data width is 16 bits, the above equation can be expressed in bit serial units like

$$for ( bit = 0 , bit < 16 ; bit ++ ) \{ \\ t 0 = a \cdot {D}^{′} [ 0 , 0 ] [ bit ] + c \cdot {D}^{′} [ 2 , 0 ] [ bit ] + a \cdot {D}^{′} [ 4 , 0 ] [ bit ] + f \cdot {D}^{′} [ 6 , 0 ] [ bit ] ; \\ t 7 = b \cdot {D}^{′} [ 1 , 0 ] [ bit ] + d \cdot {D}^{′} [ 3 , 0 ] [ bit ] + e \cdot {D}^{′} [ 5 , 0 ] [ bit ] + g \cdot {D}^{′} [ 7 , 0 ] [ bit ] ; \\ {D}_{1}^{′} [ 0 , 0 ] = {D}_{1}^{′} [ 0 , 0 ] + ( t 0 + t 7 ) << bit ; \\ {D}_{1}^{′} [ 7 , 0 ] = {D}_{1}^{′} [ 7 , 0 ] + ( t 0 - t 7 ) << bit ; \\ \}$$

Each of t0 through t7 equations can be embodied using a look-up table having 16 types of entries. In a ROM table including the look-up table, an address of a ROM is 4 bits composed of bit slices of D′[0,0],D′[2,0],D′[4,0],D[6,0] and D′[1,0],D′3,0],D′[5,0],D′[7,0] ROM table values for t0{D′[0,0],D′[2,0],D′[4,0],D′[6,0]} are
0x0000: 0
0x0001: f
0x0010: a
0x0011: f+a
0x0100: c
. . .
0x1111 a+c+a+f

t0 through t7 can also be embodied as look-up tables using ROM tables. If D₁′, which is a result of the inverse transform, after the transpose operation, the second inverse transform unit 30 can perform the inverse transform on D₁′ in the column direction in a similar way. The process of the inverse transform in the column direction is as follows.
R=[T₈·D₁+Δ+32]>>6 ,
where, Δ, which is an 8×8 matrix, is

$$Δ = [ \begin{matrix}{D}_{2 a}^{′} \\ {D}_{2 b}^{′} \\ {D}_{2 b}^{′} \\ {D}_{2 a}^{′} \\ - {D}_{2 a}^{′} \\ - {D}_{2 b}^{′} \\ - {D}_{2 b}^{′} \\ - {D}_{2 a}^{′}\end{matrix} ] , \\ where \\ [ {D}_{1 a} {D}_{1 b} ] = {D}_{1}^{′} \cdot [ \begin{matrix}0 & 0 \\ 0 & 1 \\ 0 & 0 \\ 1 & 0 \\ 0 & 0 \\ 1 & 0 \\ 0 & 0 \\ 0 & 1\end{matrix} ] \\ [ {D}_{1 a} {D}_{1 b} ] = [ \begin{matrix}{D}_{1}^{′} [ 0 , 0 ] & {D}_{1}^{′} [ 0 , 1 ] & {D}_{1}^{′} [ 0 , 2 ] & {D}_{1}^{′} [ 0 , 3 ] & {D}_{1}^{′} [ 0 , 4 ] & {D}_{1}^{′} [ 0 , 5 ] & {D}_{1}^{′} [ 0 , 6 ] & {D}_{1}^{′} [ 0 , 7 ] \\ {D}_{1}^{′} [ 1 , 0 ] & {D}_{1}^{′} [ 1 , 1 ] & {D}_{1}^{′} [ 1 , 2 ] & {D}_{1}^{′} [ 1 , 3 ] & {D}_{1}^{′} [ 1 , 4 ] & {D}_{1}^{′} [ 1 , 5 ] & {D}_{1}^{′} [ 1 , 6 ] & {D}_{1}^{′} [ 1 , 7 ] \\ {D}_{1}^{′} [ 2 , 0 ] & {D}_{1}^{′} [ 2 , 1 ] & {D}_{1}^{′} [ 2 , 2 ] & {D}_{1}^{′} [ 2 , 3 ] & {D}_{1}^{′} [ 2 , 4 ] & {D}_{1}^{′} [ 2 , 5 ] & {D}_{1}^{′} [ 2 , 6 ] & {D}_{1}^{′} [ 2 , 7 ] \\ {D}_{1}^{′} [ 3 , 0 ] & {D}_{1}^{′} [ 3 , 1 ] & {D}_{1}^{′} [ 3 , 2 ] & {D}_{1}^{′} [ 3 , 3 ] & {D}_{1}^{′} [ 3 , 4 ] & {D}_{1}^{′} [ 3 , 5 ] & {D}_{1}^{′} [ 3 , 6 ] & {D}_{1}^{′} [ 3 , 7 ] \\ {D}_{1}^{′} [ 4 , 0 ] & {D}_{1}^{′} [ 4 , 1 ] & {D}_{1}^{′} [ 4 , 2 ] & {D}_{1}^{′} [ 4 , 3 ] & {D}_{1}^{′} [ 4 , 4 ] & {D}_{1}^{′} [ 4 , 5 ] & {D}_{1}^{′} [ 4 , 6 ] & {D}_{1}^{′} [ 4 , 7 ] \\ {D}_{1}^{′} [ 5 , 0 ] & {D}_{1}^{′} [ 5 , 1 ] & {D}_{1}^{′} [ 5 , 2 ] & {D}_{1}^{′} [ 5 , 3 ] & {D}_{1}^{′} [ 5 , 4 ] & {D}_{1}^{′} [ 5 , 5 ] & {D}_{1}^{′} [ 5 , 6 ] & {D}_{1}^{′} [ 5 , 7 ] \\ {D}_{1}^{′} [ 6 , 0 ] & {D}_{1}^{′} [ 6 , 1 ] & {D}_{1}^{′} [ 6 , 2 ] & {D}_{1}^{′} [ 6 , 3 ] & {D}_{1}^{′} [ 6 , 4 ] & {D}_{1}^{′} [ 6 , 5 ] & {D}_{1}^{′} [ 6 , 6 ] & {D}_{1}^{′} [ 6 , 7 ] \\ {D}_{1}^{′} [ 7 , 0 ] & {D}_{1}^{′} [ 7 , 1 ] & {D}_{1}^{′} [ 7 , 2 ] & {D}_{1}^{′} [ 7 , 3 ] & {D}_{1}^{′} [ 7 , 4 ] & {D}_{1}^{′} [ 7 , 5 ] & {D}_{1}^{′} [ 7 , 6 ] & {D}_{1}^{′} [ 7 , 7 ]\end{matrix} ] [ \begin{matrix}0 & 0 \\ 0 & 1 \\ 0 & 0 \\ 1 & 0 \\ 0 & 0 \\ 1 & 0 \\ 0 & 0 \\ 0 & 1\end{matrix} ] .$$

However, since

$${D}_{2 a} = {D}_{1 a} >> 1$$

$${D}_{2 b} = {D}_{1 a} >> 1 , \\ [ {D}_{2 a} {D}_{2 b} ] = [ \begin{matrix}( {D}_{1}^{′} [ 0 , 3 ] + {D}_{1}^{′} [ 0 , 5 ] ) >> 1 & ( {D}_{1}^{′} [ 0 , 2 ] + {D}_{1}^{′} [ 0 , 7 ] ) >> 1 \\ ( {D}_{1}^{′} [ 1 , 3 ] + {D}_{1}^{′} [ 1 , 5 ] ) >> 1 & ( {D}_{1}^{′} [ 1 , 2 ] + {D}_{1}^{′} [ 1 , 7 ] ) >> 1 \\ ( {D}_{1}^{′} [ 2 , 3 ] + {D}_{1}^{′} [ 2 , 5 ] ) >> 1 & ( {D}_{1}^{′} [ 2 , 2 ] + {D}_{1}^{′} [ 2 , 7 ] ) >> 1 \\ ( {D}_{1}^{′} [ 3 , 3 ] + {D}_{1}^{′} [ 3 , 5 ] ) >> 1 & ( {D}_{1}^{′} [ 3 , 2 ] + {D}_{1}^{′} [ 3 , 7 ] ) >> 1 \\ ( {D}_{1}^{′} [ 4 , 3 ] + {D}_{1}^{′} [ 4 , 5 ] ) >> 1 & ( {D}_{1}^{′} [ 4 , 2 ] + {D}_{1}^{′} [ 4 , 7 ] ) >> 1 \\ ( {D}_{1}^{′} [ 5 , 3 ] + {D}_{1}^{′} [ 5 , 5 ] ) >> 1 & ( {D}_{1}^{′} [ 5 , 2 ] + {D}_{1}^{′} [ 5 , 7 ] ) >> 1 \\ ( {D}_{1}^{′} [ 6 , 3 ] + {D}_{1}^{′} [ 6 , 5 ] ) >> 1 & ( {D}_{1}^{′} [ 6 , 2 ] + {D}_{1}^{′} [ 6 , 7 ] ) >> 1 \\ ( {D}_{1}^{′} [ 7 , 3 ] + {D}_{1}^{′} [ 7 , 5 ] ) >> 1 & ( {D}_{1}^{′} [ 7 , 2 ] + {D}_{1}^{′} [ 7 , 7 ] ) >> 1\end{matrix} ] . \\ Meanwhile , \\ {T}_{8}^{′} = [ \begin{matrix}\overline{a} & \overline{b} & \overline{c} & \overline{d} & \overline{a} & \overline{e} & \overline{f} & \overline{g} \\ \overline{a} & \overline{d} & \overline{f} & - \overline{g} & - \overline{a} & - \overline{b} & - \overline{c} & - \overline{e} \\ \overline{a} & \overline{e} & - \overline{f} & - \overline{b} & - \overline{a} & \overline{g} & \overline{c} & \overline{d} \\ \overline{a} & \overline{g} & - \overline{c} & - \overline{e} & \overline{a} & \overline{d} & - \overline{f} & - \overline{b} \\ \overline{a} & - \overline{g} & - \overline{c} & \overline{e} & \overline{a} & - \overline{d} & - \overline{f} & \overline{b} \\ \overline{a} & - \overline{e} & - \overline{f} & \overline{b} & - \overline{a} & - \overline{g} & \overline{c} & - \overline{d} \\ \overline{a} & - \overline{d} & \overline{f} & \overline{g} & - \overline{a} & \overline{b} & - \overline{c} & \overline{e} \\ \overline{a} & - \overline{b} & \overline{c} & - \overline{d} & \overline{a} & - \overline{e} & \overline{f} & - \overline{g}\end{matrix} ] , \\ [ \begin{matrix}\overline{a} \\ \overline{b} \\ \overline{c} \\ \overline{d} \\ \overline{e} \\ {\overline{e}}^{′} \\ \overline{f} \\ \overline{g}\end{matrix} ] = [ \begin{matrix}6 \\ 8 \\ 8 \\ 7 \\ 4 \\ 5 \\ 3 \\ 2\end{matrix} ] .$$

where

Since D₁=(D₁′)′, D₁[i,j]=D₁′D[j,i]. Assuming that the one-dimensional inverse transform is performed on the first column of D₁ (first row of D₁), the first column of D₁ is

$$[ \begin{matrix}{D}_{1} [ 0 , 0 ] \\ {D}_{1} [ 1 , 0 ] \\ {D}_{1} [ 2 , 0 ] \\ {D}_{1} [ 3 , 0 ] \\ {D}_{1} [ 4 , 0 ] \\ {D}_{1} [ 5 , 0 ] \\ {D}_{1} [ 6 , 0 ]\end{matrix} ] = [ \begin{matrix}{D}_{1}^{′} [ 0 , 0 ] \\ {D}_{1}^{′} [ 0 , 1 ] \\ {D}_{1}^{′} [ 0 , 2 ] \\ {D}_{1}^{′} [ 0 , 3 ] \\ {D}_{1}^{′} [ 0 , 4 ] \\ {D}_{1}^{′} [ 0 , 5 ] \\ {D}_{1}^{′} [ 0 , 6 ]\end{matrix} ] .$$

8×8 block T₈·D₁, which is a partial output, that is, a first column vector of Y₁, is

$$[ \begin{matrix}{Y}_{1} [ 0 , 0 ] \\ {Y}_{1} [ 1 , 0 ] \\ {Y}_{1} [ 2 , 0 ] \\ {Y}_{1 } [ 3 , 0 ]\end{matrix} ] = [ \begin{matrix}\overline{a} & \overline{c} & \overline{a} & \overline{f} \\ \overline{a} & \overline{f} & - \overline{a} & - \overline{c} \\ \overline{a} & - \overline{f} & - \overline{a} & \overline{c} \\ \overline{a} & - \overline{c} & \overline{a} & - \overline{f}\end{matrix} ] [ \begin{matrix}{D}_{1} [ 0 , 0 ] \\ {D}_{1} [ 2 , 0 ] \\ {D}_{1} [ 4 , 0 ] \\ {D}_{1} [ 6 , 0 ]\end{matrix} ] + [ \begin{matrix}\overline{b} & \overline{d} & \overline{e} & \overline{g} \\ \overline{d} & - \overline{g} & - \overline{b} & - \overline{e} \\ \overline{e} & - \overline{b} & \overline{g} & \overline{d} \\ \overline{g} & - \overline{e} & \overline{d} & - \overline{b}\end{matrix} ] [ \begin{matrix}{D}_{1} [ 1 , 0 ] \\ {D}_{1} [ 3 , 0 ] \\ {D}_{1} [ 5 , 0 ] \\ {D}_{1} [ 7 , 0 ]\end{matrix} ] \\ [ \begin{matrix}{Y}_{1} [ 7 , 0 ] \\ {Y}_{1} [ 6 , 0 ] \\ {Y}_{1} [ 5 , 0 ] \\ {Y}_{1 } [ 4 , 0 ]\end{matrix} ] = [ \begin{matrix}\overline{a} & \overline{c} & \overline{a} & \overline{f} \\ \overline{a} & \overline{f} & - \overline{a} & - \overline{c} \\ \overline{a} & - \overline{f} & - \overline{a} & \overline{c} \\ \overline{a} & - \overline{c} & \overline{a} & - \overline{f}\end{matrix} ] [ \begin{matrix}{D}_{1} [ 0 , 0 ] \\ {D}_{1} [ 2 , 0 ] \\ {D}_{1} [ 4 , 0 ] \\ {D}_{1} [ 6 , 0 ]\end{matrix} ] + [ \begin{matrix}\overline{b} & \overline{d} & \overline{e} & \overline{g} \\ \overline{d} & - \overline{g} & - \overline{b} & - \overline{e} \\ \overline{e} & - \overline{b} & \overline{g} & \overline{d} \\ \overline{g} & - \overline{e} & \overline{d} & - \overline{b}\end{matrix} ] [ \begin{matrix}{D}_{1} [ 1 , 0 ] \\ {D}_{1} [ 3 , 0 ] \\ {D}_{1} [ 5 , 0 ] \\ {D}_{1} [ 7 , 0 ]\end{matrix} ] .$$

If the first column vectors of Y₁ is expressed as pseudo-C codes,

$$\{ \\ t 0 = \overline{a} \cdot {D}_{1} [ 0 , 0 ] + \overline{c} \cdot {D}_{1} [ 2 , 0 ] + \overline{a} \cdot {D}_{1} [ 4 , 0 ] + \overline{f} \cdot {D}_{1} [ 6 , 0 ] ; \\ t 7 = \overline{b} \cdot {D}_{1} [ 1 , 0 ] + \overline{d} \cdot {D}_{1} [ 3 , 0 ] + \overline{e} \cdot {D}_{1} [ 5 , 0 ] + \overline{g} \cdot {D}_{1} [ 7 , 0 ] ; \\ {Y}_{1} [ 0 , 0 ] = t 0 + t 7 ; \\ {Y}_{1} [ 7 , 0 ] = t 0 - t 7 ; \\ \\ t 1 = \overline{a} \cdot {D}_{1} [ 0 , 0 ] + \overline{f} \cdot {D}_{1} [ 2 , 0 ] - \overline{a} \cdot {D}_{1} [ 4 , 0 ] - \overline{c} \cdot {D}_{1} [ 6 , 0 ] ; \\ t 6 = \overline{d} \cdot {D}_{1} [ 1 , 0 ] - \overline{g} \cdot {D}_{1} [ 3 , 0 ] - \overline{b} \cdot {D}_{1} [ 5 , 0 ] - \overline{e} \cdot {D}_{1} [ 7 , 0 ] ; \\ {Y}_{1} [ 1 , 0 ] = t 1 + t 6 ; \\ {Y}_{1} [ 6 , 0 ] = t 1 - t 6 ; \\ \\ t 2 = \overline{a} \cdot {D}_{1} [ 0 , 0 ] - \overline{f} \cdot {D}_{1} [ 2 , 0 ] - \overline{a} \cdot {D}_{1} [ 4 , 0 ] + \overline{c} \cdot {D}_{1} [ 6 , 0 ] ; \\ t 5 = \overline{e} \cdot {D}_{1} [ 1 , 0 ] - \overline{b} \cdot {D}_{1} [ 3 , 0 ] + \overline{g} \cdot {D}_{1} [ 5 , 0 ] + \overline{d} \cdot {D}_{1} [ 7 , 0 ] ; \\ {Y}_{1} [ 2 , 0 ] = t 2 + t 5 ; \\ {Y}_{1} [ 5 , 0 ] = t 2 - t 5 ; \\ \\ t 3 = \overline{a} \cdot {D}_{1} [ 0 , 0 ] - \overline{c} \cdot {D}_{1} [ 2 , 0 ] + \overline{a} \cdot {D}_{1} [ 4 , 0 ] - \overline{f} \cdot {D}_{1} [ 6 , 0 ] ; \\ t 4 = \overline{g} \cdot {D}_{1} [ 1 , 0 ] - \overline{e} \cdot {D}_{1} [ 3 , 0 ] + \overline{d} \cdot {D}_{1} [ 5 , 0 ] - \overline{b} \cdot {D}_{1} [ 7 , 0 ] ; \\ {Y}_{1} [ 3 , 0 ] = t 3 + t 4 ; \\ {Y}_{1} [ 4 , 0 ] = t 3 - t 4 ; \\ \}$$

If data width is 16 bits, the above equation can be expressed in bit serial units like

$$for ( bit = 0 , bit < 16 ; bit ++ ) \{ \\ t 0 = \overline{a} \cdot {D}_{1} [ 0 , 0 ] [ bit ] + \overline{c} \cdot {D}_{1} [ 2 , 0 ] [ bit ] + \overline{a} \cdot {D}_{1} [ 4 , 0 ] [ bit ] + \overline{f} \cdot {D}_{1} [ 6 , 0 ] [ bit ] ; \\ t 7 = \overline{b} \cdot {D}_{1} [ 1 , 0 ] [ bit ] + \overline{d} \cdot {D}_{1} [ 3 , 0 ] [ bit ] + \overline{e} \cdot {D}_{1} [ 5 , 0 ] [ bit ] + \overline{g} \cdot {D}_{1} [ 7 , 0 ] [ bit ] ; \\ {Y}_{1} [ 0 , 0 ] = {Y}_{1} [ 0 , 0 ] + ( t 0 + t 7 ) ⪡ bit ; \\ {Y}_{1} [ 7 , 0 ] = {Y}_{1} [ 7 , 0 ] + ( t 0 - t 7 ) ⪡ bit ; \\ \} .$$

Each of t0 through t7 equations can be embodied as a look-up table using a ROM table as in the one-dimensional inverse transform in the row direction. That is, ROM table values for t0{D₁[0,0], D₁[2,0], D₁[4,0], D₁[6,0]} are
0x0001: f
0x0010: a
0x0011: \overline{f}+\overline{a}
0x0100: \overline{c}
. . .
0x1111: \overline{a}+\overline{c}+\overline{a}+\overline{f}

to through t7 can be embodied similarly. Finally, an output value Y can be calculated using Y[0,0]=(Y₁[0,0]+((D₁′[0,3]+D₁′[5,0])>>1)+32)>>6=(Y₁[0,0]+((D₁[3,0]+Dₐ[5,0])>>1)>>6;

Similarly, output values Y can be obtained using

$$Y [ 1 , 0 ] = ( {Y}_{1} [ 1 , 0 ] + ( ( {D}_{1} [ 2 , 0 ] + {D}_{1} [ 7 , 0 ] ) ⪢ 1 ) + 32 ) ⪢ 6 ;$$

$$Y [ 2 , 0 ] = ( {Y}_{1} [ 2 , 0 ] + ( ( {D}_{1} [ 2 , 0 ] + {D}_{1} [ 7 , 0 ] ) ⪢ 1 ) + 32 ) ⪢ 6 ;$$

$$Y [ 3 , 0 ] = ( {Y}_{1} [ 3 , 0 ] + ( ( {D}_{1} [ 3 , 0 ] + {D}_{1} [ 5 , 0 ] ) ⪢ 1 ) + 32 ) ⪢ 6 ;$$

$$Y [ 4 , 0 ] = ( {Y}_{1} [ 4 , 0 ] - ( ( {D}_{1} [ 3 , 0 ] + {D}_{1} [ 5 , 0 ] ) ⪢ 1 ) + 32 ) ⪢ 6 ;$$

$$Y [ 5 , 0 ] = ( {Y}_{1} [ 5 , 0 ] - ( ( {D}_{1} [ 2 , 0 ] + {D}_{1} [ 7 , 0 ] ) ⪢ 1 ) + 32 ) ⪢ 6 ;$$

$$Y [ 6 , 0 ] = ( {Y}_{1} [ 6 , 0 ] - ( ( {D}_{1} [ 2 , 0 ] + {D}_{1} [ 7 , 0 ] ) ⪢ 1 ) + 32 ) ⪢ 6 ;$$

$$Y [ 7 , 0 ] = ( {Y}_{1} [ 7 , 0 ] - ( ( {D}_{1} [ 3 , 0 ] + {D}_{1} [ 5 , 0 ] ) ⪢ 1 ) + 32 ) ⪢ 6 ; .$$

71 The two items from the right side of the above equations extract two components from an input vector, obtains (D₁[2,0]+D₁[7,0])>>1 and (D₁[3,0]+D₁[5,0])>>1, adds Y₁[.,.] (D₁[2,0+D[7,0])>>1 and (D₁[3,0]+D₁[5,0])>>1, rounds the result of the addition, and generates an output value. The remaining column vectors (1←j←7) are obtained as follows.

$$Y [ 0 , j ] = ( {Y}_{1} [ 0 , j ] + ( ( {D}_{1} [ 3 , j ] + {D}_{1} [ 5 , j ] ) ⪢ 1 ) + 32 ) ⪢ 6 ;$$

$$Y [ 1 , j ] = ( {Y}_{1} [ 1 , j ] + ( ( {D}_{1} [ 2 , j ] + {D}_{1} [ 7 , j ] ) ⪢ 1 ) + 32 ) ⪢ 6 ;$$

$$Y [ 2 , j ] = ( {Y}_{1} [ 2 , j ] + ( ( {D}_{1} [ 2 , j ] + {D}_{1} [ 7 , j ] ) ⪢ 1 ) + 32 ) ⪢ 6 ;$$

$$Y [ 3 , j ] = ( {Y}_{1} [ 3 , j ] + ( ( {D}_{1} [ 3 , j ] + {D}_{1} [ 5 , j ] ) ⪢ 1 ) + 32 ) ⪢ 6 ;$$

$$Y [ 4 , j ] = ( {Y}_{1} [ 4 , j ] - ( ( {D}_{1} [ 3 , j ] + {D}_{1} [ 5 , j ] ) ⪢ 1 ) + 32 ) ⪢ 6 ;$$

$$Y [ 5 , j ] = ( {Y}_{1} [ 5 , j ] - ( ( {D}_{1} [ 2 , j ] + {D}_{1} [ 7 , j ] ) ⪢ 1 ) + 32 ) ⪢ 6 ;$$

$$Y [ 6 , j ] = ( {Y}_{1} [ 6 , j ] - ( ( {D}_{1} [ 2 , j ] + {D}_{1} [ 7 , j ] ) ⪢ 1 ) + 32 ) ⪢ 6 ;$$

$$Y [ 7 , j ] = ( {Y}_{1} [ 7 , j ] - ( ( {D}_{1} [ 3 , j ] + {D}_{1} [ 5 , j ] ) ⪢ 1 ) + 32 ) ⪢ 6 ; .$$

Since values of T₈and T₈ are different, two one-dimensional inverse transforms require separate ROM tables. However, in reality, the two one-dimensional inverse transform can share t0 through t3 ROM tables. In other words, the one-dimensional inverse transform in the column direction can use the t0 through t3 ROM tables used for the one-dimensional inverse transform in the row direction by simply right-shifting output values of the t0 through t3 ROM tables by one 1 bit. However, separate t4 through t7 ROM tables are required for the one-dimensional inverse transform in the column direction.

The 8×8 inverse transform has been described above using an example. Since ROM tables for the 8×4, 4×8, and 4×4 inverse transforms can be obtained in a similar way, the methods of obtaining ROM tables for the 8×4, 4×8, and 4×4 inverse transforms will not be described herein.

As described above, the present invention provides an inverse transform method, apparatus, and medium unrestricted by the size or type of input data. Accordingly, data of various sizes, such as 8×8, 8×4, 4×8, and 4×4, can be inverse-transformed using the same hardware structure by providing separate ROM table groups. Also, 8×8 data of MPEG as well as VC9 can be inverse-transformed using the same hardware structure. In other words, if the inverse transform method and apparatus according to the present invention is used, a multi-format decoder can be embodied.

It is possible for the exemplary inverse transform methods for a moving-image codec as described above according to the present invention to be implemented as a computer program. Codes and code segments constituting the computer program may be provided by those skilled in the art. The computer programs may be recorded on computer-readable media and read and executed by computers, computing devices, processors, programmable apparatuses, and the like. Such computer-readable media include all kinds of storage devices, such as ROM, RAM, CD-ROM, magnetic tape, floppy disc, optical data storage devices, etc. The computer readable media also include everything that is realized in the form of carrier waves, e.g., transmission over the Internet. The computer-readable media may be distributed to computers, computing devices, processors, programmable apparatuses, computer systems, and the like connected to a network, and codes on the distributed computer-readable media may be stored and executed in a decentralized fashion.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. An inverse transform apparatus included in a moving-image codec, the apparatus comprising:
a plurality of ROM tables separately included according to a format or a size of input data to be referred to in performing an inverse transform; and
an inverse transform processor selecting one of the ROM tables according to the format or the size of the input data and performing an inverse transform on the input data.

2. The apparatus of claim 1, wherein the format comprises at least one of MPEG-2 and VC9.

3. The apparatus of claim 1, wherein the size comprises at least one of 8×8, 8×4, 4×8, and 4×4.

4. The apparatus of claim 1, wherein the inverse transform processor has the same structure regardless of the format or the size of the input data.

5. An image codec apparatus comprising the inverse transform apparatus of claim 1 and supporting multi-formats.

6. An inverse transform method for a moving-image codec, the method comprising:
selecting one of a plurality of ROM tables, which are separately included according to a format or a size of input data, according to the format or the size of the input data; and
performing an inverse transform on the input data with reference to the selected ROM table.

7. The method of claim 6, wherein the format comprises at least one of MPEG-2 and VC9.

8. The method of claim 6, wherein the size comprises at least one of 8×8, 8×4, 4×8, and 4×4.

9. At least one computer readable medium storing instructions that control at least one processor to perform an inverse transform method for a moving-image codec, the method comprising:
selecting one of a plurality of ROM tables, which are separately included according to a format or a size of input data, according to the format or the size of the input data; and
performing an inverse transform on the input data with reference to the selected ROM table.

10. The medium of claim 9, wherein the format comprises at least one of MPEG-2 and VC9.

11. The medium of claim 9, wherein the size comprises at least one of 8×8, 8×4, 4×8, and 4×4.
